(19) United States
(12) Patent Application Publication
(10) Pub. No.: US 2025/0306165 A1
(43) Pub. Date: Oct. 2, 2025

(54) RADAR CONTROL DEVICE AND METHOD

(71) Applicant: HL Klemove Corp., Incheon (KR)

(72) Inventor: Jee Hoon SON, Incheon (KR)

(73) Assignee: HL Klemove Corp., Incheon (KR)

(21) Appl. No.: 18/809,444

(22) Filed: Aug. 20, 2024

(30) Foreign Application Priority Data
Mar. 28, 2024 (KR) 10-2024-0042830

(51) Int. Cl. G01S 7/02; G01S 7/35; G01S 13/931

(52) U.S. Cl. CPC G01S 7/023; G01S 7/354; G01S 13/931

(57) ABSTRACT

The present embodiments relate to a technology for a radar control device and method for transmitting a transmission signal, receiving a reception signal, controlling to change a frequency of the transmission signal at a preset interval, calculating a frequency deviation between the transmission signal and the reception signal, and extracting the interference signal based on the frequency deviation to extract and remove an interference signal causing ghosting in a radar device.

### CROSS-REFERENCE TO RELATED APPLICATION

This application claims priority from Korean Patent Application No. 10-2024-0042830, filed on Mar. 28, 2024, which is hereby incorporated by reference for all purposes as if fully set forth herein.

### BACKGROUND

### Field

The present embodiments relate to a radar control device and method.

### Description of Related Art

As autonomous driving systems become more common, there are more situations in which signals come and go between vehicle radar devices on the public road. The radar device is an active sensor that transmits and receives signals, and may normally transmit and receive signals when there is a single sensor. However, when a plurality of radar devices exchange signals, interference may occur between the signals, causing reception of inaccurate information. When any external signal enters the radar device and causes interference, a phenomenon (“ghosting”) in which a target exists even though there is actually no target may occur. In other words, it is difficult for the radar device to work properly in an environment in which severe interference signals are generated.

Therefore, in order to detect ghosting, it is necessary to prepare a method capable of avoiding or minimizing an interference effect between radar devices. Various methods for detecting ghosting have been proposed. However, there is an increasing need for a technology for preventing the occurrence of ghosting by accurately detecting and removing any external signal using a transmission signal and a reception signal of a radar device.

### BRIEF SUMMARY

The present embodiments may provide a radar control device for removing interference signals that cause ghosting in a radar device.

The present embodiments may provide a radar control method for removing interference signals that cause ghosting in a radar device.

In an aspect, the present embodiments may provide a radar control device of a vehicle comprising a transceiver transmitting a transmission signal and receiving a reception signal, a transmission signal controller controlling to change a frequency slope of the transmission signal at a preset interval, and a reception signal processor calculating a frequency deviation between the transmission signal and the reception signal and extracting an interference signal based on the frequency deviation.

In another aspect, the present embodiments may provide a radar control method of a vehicle comprising a transmitting a transmission signal and receiving a reception signal, a controlling to change a frequency slope of the transmission signal at a preset interval, and a processing a reception signal calculating a frequency deviation between the transmission signal and the reception signal and extracting an interference signal based on the frequency deviation.

The present embodiments may provide a radar control device and method for removing interference signals.

### DESCRIPTION OF DRAWINGS

The above and other objects, features, and advantages of the disclosure will be more clearly understood from the following detailed description, taken in conjunction with the accompanying drawings, in which:

FIG. 1 is a view illustrating a radar control device according to the present embodiments;

FIG. 2 is a view illustrating a transmission method and a reception method of a transceiver according to the present embodiments;

FIG. 3 is a view illustrating a transmission signal having a changed frequency slope according to the present embodiments;

FIG. 4 is a view illustrating an operation of extracting an interference signal based on a frequency deviation according to the present embodiments; and

FIG. 5 is a flowchart illustrating a radar control method according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

The radar control device in the disclosure is a device for controlling a radar device to detect an object and remove interference signals using a reception signal of a transmission signal of a host vehicle, reflected by the object, or a reception signal of a transmission signal of another vehicle, received by the host vehicle and means a control unit for controlling the operation of radar. Further, the radar device may be implemented as a frequency modulated continuous wave (FMCW) radar. However, this is merely an example, and if the content according to the disclosure may be applied, it is not limited to a specific type of radar. Further, the description focuses primarily on an example in which the radar device is mounted to a vehicle but, without limitations thereto, it may be applied to various radar devices such as a military radar device, a commercial radar device, and the like. Further, the radar device according to the disclosure may include at least one vehicle radar sensor unit, e.g., one or more of a front detection radar device mounted on a front surface of the vehicle, a rear radar device mounted on a rear surface of the vehicle, and a side direction or side rear detection radar device mounted on each side of the vehicle. Further, the radar control device may analyze the transmission signal and the reception signal to process the data, thereby detecting information about the object and, to that end, may include an electronic control unit (ECU) or a processor. Data transmission or signal communication from the radar to the ECU may use a communication link such as a vehicle network bus.

Hereinafter, a radar control device and method according to the disclosure is described with reference to the drawings.

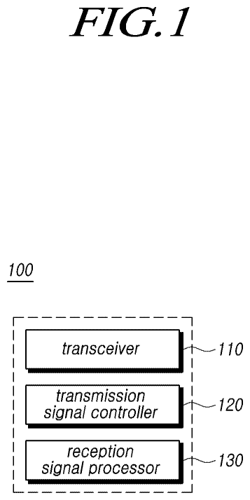

FIG. 1 is a view illustrating a radar control device 100 according to the present embodiments.

A radar control device 100 of a vehicle may include a transceiver 110 transmitting a transmission signal and receiving a reception signal, a transmission signal controller 120 controlling to change a frequency slope of the transmission signal at a preset interval, and a reception signal processor 130 calculating a frequency deviation between the transmission signal and the reception signal and extracting an interference signal based on the frequency deviation.

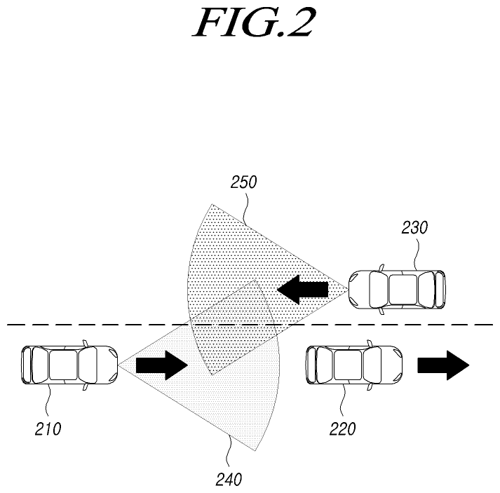

The radar control device 100 may include a transceiver 110 that transmits a transmission signal and receives a reception signal. Although the transmission signal and the reception signal have been described above, a method for transmitting the transmission signal and a method for receiving the reception signal are described below with reference to FIG. 2.

The radar control device 100 may include the transmission signal controller 120 for controlling to change frequency slope of the transmission signal at a preset interval.

For example, the preset interval may be set based on a chirp and a scan.

The chirp may refer to one form in which the frequency increases or decreases over time when the horizontal axis is the time and the vertical axis is the frequency with respect to a two-dimensional graph. The transmission signal of the disclosure may refer to a signal having a chirp-type period in an FMCW format. Further, the scan may mean a form set to be composed of tens to hundreds of chirps. However, scan encompasses chirp in concept, and in the operation of controlling to change the frequency slope described below, the description focuses only on chirp.

For example, the frequency slope may be defined based on the above-described chirp. For example, the frequency slope may mean the degree to which the frequency increases or decreases over time, which may be calculated from a form of a chirp.

For example, the preset interval may be set based on A chirps (where A is a natural number of 1 or more), and accordingly, the frequency slope of the transmission signal may be controlled to be changed.

For example, the frequency slope of the transmission signal may be controlled to be changed at a preset interval. For example, the frequency slope of the transmission signal may be controlled to be changed for each chirp. In other words, after a transmission signal is transmitted at a specific frequency slope in one chirp, a transmission signal of which a specific frequency slope is changed may be transmitted in the next one chirp. As another example, the frequency of the transmission signal may be controlled to be changed in slope every three chirps. In other words, after three transmission signals are transmitted at a specific frequency slope in three chirps, a transmission signal of which a specific frequency slope is changed may be transmitted in the next three chirps. As another example, after three transmission signals are transmitted at a specific frequency slope in three chirps, the specific frequency slope is changed in one chirp and one transmission signal may be transmitted.

However, the preset interval may be set without limitations thereto.

For example, the transmission signal controller 120 may control to change the frequency slope of the transmission signal.

For example, the transmission signal controller 120 may control to transmit a first transmission signal controlled to have a normal frequency slope and a second transmission signal controlled to have a change frequency slope differentiated from the normal frequency slope.

Further, the change frequency slope may be set to be N times the normal frequency slope, and N may be set to a positive or negative number.

For example, the first transmission signal may be controlled to have the normal frequency slope, and the second transmission signal may be controlled to have a change frequency slope differentiated from the normal frequency slope. The change frequency slope may be set to be N times the normal frequency slope.

In this case, in order to calculate the frequency deviation described below to effectively extract the interference signal, the change frequency slope may be set to be N times the normal frequency slope, and N may be set to a positive or negative number.

For example, the change frequency slope may be set to be-1 times the normal frequency slope. In this case, the first transmission signal and the second transmission signal may have the same absolute value of the frequency slope, but may be determined to be inverted from each other. Accordingly, by using the first transmission signal and the second transmission signal inverted from each other, it may be easy to calculate a frequency deviation to be described below, and it may be more efficient to extract an interference signal included in the reception signal. In the present embodiments, for convenience of description, N is assumed to be-1 times, but N in the N times the slope may be variously set without limitations in the present embodiments.

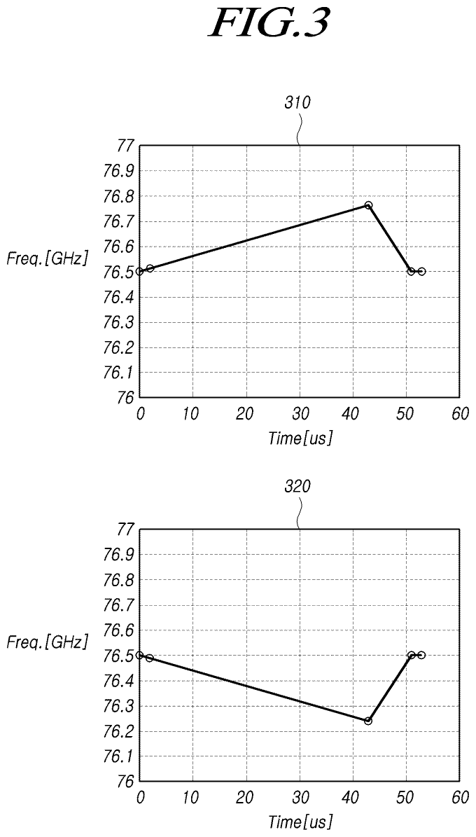

The frequency slope is described below with reference to FIG. 3.

The radar control device 100 may include a reception signal processor 130 that calculates a frequency deviation between the transmission signal and the reception signal and extracts the interference signal based on the frequency deviation.

For example, the frequency deviation may be calculated in a manner of comparing the frequency of the transmission signal with the frequency of the reception signal to obtain the deviation. Accordingly, the frequency deviation may be calculated in a real number range (a range including a positive number, a negative number, and zero).

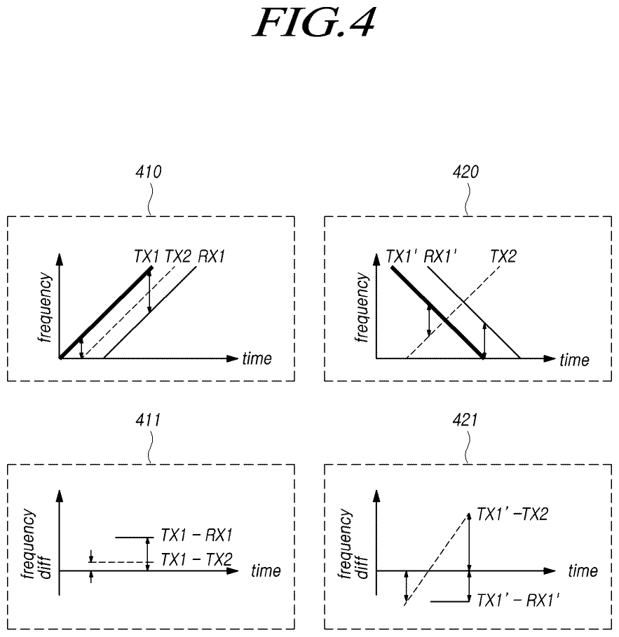

For example, the reception signal processor 130 may calculate the frequency deviation between the transmission signal and the reception signal and extract the interference signal according to the variation in the frequency deviation. The frequency deviation and the variation in the frequency deviation are described below with reference to FIG. 4.

For example, the reception signal processor 130 may extract the interference signal by extracting a difference between a first frequency deviation calculated as a deviation between the first transmission signal and the reception signal and a second frequency deviation calculated as a deviation between the second transmission signal and the reception signal, as the variation in the frequency deviation.

For example, the variation in the frequency deviation may be calculated by comparing the time and frequency deviations based on the first frequency deviation and the second frequency deviation. Further, the variation in the frequency deviation may be extracted based on a preset threshold to be described below, and may be extracted based on an absolute value. Further, the variation in the frequency deviation may be extracted using the second transmission signal and the reception signal. For example, the form of the variation in the frequency deviation may include a form having a constant deviation over time, or may include a form in which the frequency deviation increases or decreases over time. Further, when the vehicle is driving, the variation in the frequency deviation may be variably calculated according to the speed. However, without limitations thereto, the variation in frequency deviation may be variously extracted. It is described below in greater detail with reference to FIG. 4.

For example, the reception signal processor 130 may extract the reception signal as the interference signal when the variation in the frequency deviation is larger than or equal to a predetermined threshold.

For example, the preset threshold may be preset with respect to the variation in the frequency deviation. For example, the preset threshold may mean a specific frequency deviation value when the specific frequency deviation is maintained for a predetermined time. Alternatively, it may mean a specific frequency deviation value when the absolute value of the specific frequency deviation is maintained for a predetermined time. Here, the predetermined time may be set to vary. It is described below in greater detail with reference to FIG. 4.

As another example, the reception signal processor 130 may apply an absolute value to each of the first frequency deviation and the second frequency deviation, extract a variation in the frequency deviation of the absolute value-applied first frequency deviation and the absolute value-applied second frequency deviation, and extract the reception signal as the interference signal when the variation in the frequency deviation exists.

For example, the variation in the frequency deviation may be extracted based on the absolute value of each of the first frequency deviation and the second frequency deviation. Here, the variation in the frequency deviation may mean a difference between the slopes of the absolute values of the first frequency deviation and the second frequency deviation. Here, if the variation in the frequency deviation is close to 0, it may be determined that the variation in the frequency deviation does not exist. Further, if there is a variation in frequency deviation, the reception signal may be extracted as the interference signal. However, without limitations thereto, the variation in frequency deviation may be extracted. It is described below in greater detail with reference to FIG. 4.

As another example, the reception signal processor 130 may extract the reception signal as the interference signal when the frequency deviation is changed.

Further, the frequency deviation may be calculated using the second transmission signal and the reception signal. Further, when the frequency deviation is changed, the reception signal may be extracted as the interference signal. Due to the nature of the radar signal, the frequency deviation between the transmission signal and the reception signal reflected by the object targeted by the transmission signal may not be large in variation width. However, since the transmission signal and the interference signal may not be set to be the same or similar in frequency, period, or the like in advance, a change in frequency deviation may occur. It is described below in greater detail with reference to FIG. 4. Further, the operation of calculating the frequency deviation by the reception signal processor 130 and the operation of extracting the interference signal are described below in detail with reference to FIG. 4.

For example, the reception signal processor 130 may process the reception signal by deleting the pattern of the interference signal or the object according to the interference signal from the reception signal.

The reception signal processor 130 may process the reception signal by deleting the pattern of the interference signal or the object included therein with respect to the extracted interference signal. Accordingly, the reception signal is a signal in which ghosting does not occur, and may make it easy to drive the vehicle in the autonomous driving system.

Hereinafter, the operation of controlling to change the frequency slope of the radar control device of the vehicle, the operation of calculating the frequency deviation between the transmission signal and the reception signal, and the operation of extracting the interference signal based on the frequency deviation are individually described. Each operation may be applied independently or in combination.

FIG. 2 is a view illustrating a transmission method and a reception method of a transceiver according to the present embodiments.

The transceiver may transmit a transmission signal 240 and receive a reception signal.

For example, the transceiver of the vehicle 210 may transmit the transmission signal 240 toward the front. Further, the transceiver of another vehicle 230 may transmit the transmission signal 250 toward the front. In this case, the transceiver of the vehicle 210 may receive the reception signal which is the transmission signal 240 reflected by the object 220. Further, the transceiver of the vehicle 210 may receive the transmission signal 250 of the other vehicle 230 as the reception signal. However, the transmission signal 240 and 250 and the reception signal are signals in the form of a frequency, and may cause interference therebetween. Thus, without extracting and removing interference signals, inaccurate information may be detected. The inaccurate information may cause an accident in an autonomous driving system. Accordingly, in the disclosure, an operation of extracting and removing an interference signal based on a transmission signal and a reception signal according to the present embodiments may be performed.

Further, a vehicle is illustrated as the object 220 in the present embodiments, but various objects may be set as long as they are objects to be distinguished, such as persons, vehicles, or guardrails. Further, in the present embodiments, the transmission signal 240 is transmitted toward the front, but the transmission signal 240 may be transmitted not only toward the front but also toward the side, the rear, and the like.

FIG. 3 is a view illustrating a transmission signal having a changed frequency slope according to the present embodiments.

For example, the transmission signal controller may control to transmit a first transmission signal controlled to have a normal frequency slope and a second transmission signal controlled to have a change frequency slope differentiated from the normal frequency slope.

For example, the first graph 310 may refer to a graph for a first transmission signal controlled to have a normal frequency slope. The second graph may refer to a graph for a second transmission signal controlled to have a change frequency slope distinguished from the normal frequency slope. The horizontal axis of the first graph 310 and the second graph 320 is set to time and the vertical axis is set to frequency. Here, the unit of time may be set to microsecond (us) and the frequency unit may be set to gigahertz (GHz).

Referring to the first graph 310, the frequency is changed from 76.5 GHz to about 76.75 GHz between 0 us and about 40 us. Further, the frequency is changing from about 76.75 GHz to about 76.5 GHz between about 40 us and 50 us. Referring to the second graph 320, the frequency is changed from 76.5 GHz to about 76.25 GHZ during the same time. Further, the frequency is changing from about 76.25 GHz to about 76.5 GHz between about 40 us and 50 us. In other words, when the shape of the second graph 320 is compared with the shape of the first graph 310, the slope is set to be-1 times. In other words, the second transmission signal may be set to-1 times the slope of the first transmission signal, i.e., a negative multiple.

However, in the present embodiments, only-1 times the normal frequency slope is exemplified as the change frequency slope for convenience of description but, without limitations thereto, may be variously set in a range that is a positive or negative multiple.

FIG. 4 is a view illustrating an operation of extracting an interference signal based on a frequency deviation according to the present embodiments.

Referring to FIG. 4, the reception signal processor may calculate a frequency deviation between the transmission signal TX1 and TX1′ and the reception signal TX2, RX1, and RX1′, and extract the interference signal according to the variation in the frequency deviation.

For example, TX1 may refer to the first transmission signal controlled to have the normal frequency slope, and TX1′ may refer to the second transmission signal controlled to have the change frequency slope. In the present embodiments, the change frequency slope of TX1′ is set to −1 times the normal frequency slope of TX1. However, the set multiple of the slope is not limited to the present embodiments and may be set to various multiples. (However, the multiple should be a positive or negative number.) For convenience of description, it is described below assuming that TX1 and TX1′ have the same absolute value, except that only the slope is set to −1 times.

For example, TX2 may mean the reception signal received from the transmission signal of another vehicle, i.e., the interference signal. Further, RX1 may mean the reception signal received based on the first transmission signal, and RX1′ may mean the reception signal received based on the second transmission signal.

The first graph 410 is a graph illustrating frequencies per hour of the first transmission signal and the reception signal. The second graph 411 is a graph illustrating the first frequency deviation. The third graph 420 is a graph illustrating the frequency per hour of the second transmission signal and the reception signal. The fourth graph 421 is a graph illustrating the second frequency deviation.

Hereinafter, for convenience of description, the signal processing operation of the reception signal processor is described using the first graph 410 to the fourth graph 421.

For example, the reception signal processor may extract a difference between a first frequency deviation TX1-RX1 and TX1-TX2 calculated as a deviation between a first transmission signal and a reception signal and a second frequency deviation TX1′-RX1′ and TX1′-TX2 calculated as a deviation between the second transmission signal and the reception signal, as a variation in frequency deviation and extract an interference signal TX2. By comparing the variations in the four frequency deviations using the second graph 411 and the fourth graph 421, the interference signal may be extracted more accurately and intuitively. For convenience of description, TX1-RX1 is defined as the first deviation, TX1-TX2 is defined as the second deviation, TX1′-RX1′ is defined as the third deviation, and TX1′-TX2 is defined as the fourth deviation. However, the present embodiments are not limited thereto, and various frequency variations may be set.

For example, the reception signal processor may extract the reception signal TX2 as the interference signal when the variation in the frequency deviation is larger than or equal to a preset threshold.

In the present embodiments, the preset threshold may be set to a frequency deviation value when a specific frequency deviation value is maintained for a predetermined time, such as the first deviation or the third deviation. Further, the preset threshold may be set according to the speed of the vehicle, may be set according to a change in the environment, or may be set according to the transmission signal. The preset threshold is not limited to the present embodiments and may be variously preset.

For example, when comparing the first deviation and the third deviation of the second graph 411 and the fourth graph 421, it may be determined that the variations in frequency deviation are similar in absolute value, except for the different signs. Therefore, it may not be determined that RX1 and RX1′, which are factors of the first deviation and the third deviation, exceed the preset threshold. However, when comparing the second deviation and the fourth deviation, it may be determined that the variation in the frequency deviation differs from that when the first deviation and the third deviation are compared. While the second deviation shows the same variation in frequency deviation over time like the frequency deviation and third deviation, the fourth deviation shows a variation in frequency deviation in the form of the frequency increasing over time. In other words, the fourth deviation may be determined to correspond to the preset threshold or more. Accordingly, it may be determined that TX2, which is the factor of the fourth deviation, corresponds to the interference signal.

As another example, the reception signal processor may apply an absolute value to each of the first frequency deviation TX1-RX1 and TX1-TX2 and the second frequency deviation TX1 ‘-TX2 and TX1’-RX1′, extract a variation in the frequency deviation of the absolute value-applied first frequency deviation TX1-RX1 and TX1-TX2 and the absolute value-applied second frequency deviation TX1′-TX2 and TX1′-RX1′, and extract the reception signal TX2 as an interference signal when there is the variation in the frequency deviation.

Since the absolute values of the transmission signals, which are factors of the first deviation and the third deviation, are the same but differ only in slope, it may be determined that the absolute values of the first deviation and the third deviation are similar. Accordingly, it may be determined that there is little or no variation in the frequency deviation of the first deviation and the third deviation. However, the second deviation and the fourth deviation may not be determined as similar in absolute value. The second deviation may be determined to have a specific frequency deviation value while the fourth deviation shows a form of the frequency deviation increasing or decreasing over time. In other words, it may be determined that there is a variation in the frequency deviation through the fourth deviation. Accordingly, TX2, which is a factor of the fourth deviation, may be extracted as an interference signal.

For example, the reception signal processor may extract the reception signal TX2 as an interference signal when the frequency deviation is changed. Further, the frequency deviation may be calculated using the second transmission signal TX1′ and the reception signals RX1′ and TX2.

In this case, when calculating the frequency deviation, it may be difficult for the reception signal processor to find the variation in the frequency deviation using the first deviation and the second deviation. Accordingly, the reception signal processor may calculate the frequency deviation using the third deviation and the fourth deviation calculated using the second transmission signal TX1′ and the reception signals RX1′ and TX2. Further, the reception signal TX2 may be extracted as the interference signal using the case where the third deviation and the fourth deviation are changed.

As a specific example, the third deviation may be calculated as a deviation between the second transmission signal TX1′ and the reception signal RX1′, and the fourth deviation may be calculated as a deviation between the second transmission signal TX1′ and the reception signal TX2. Here, the fourth deviation compared to the third deviation may be determined to have a variation in frequency per specific time. Accordingly, TX2, which is the reception signal of the fourth deviation, may be determined as the interference signal.

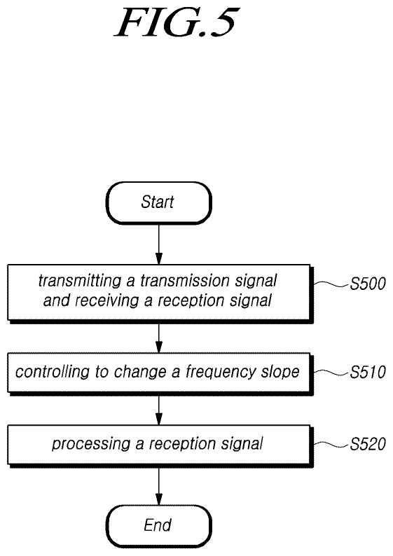

FIG. 5 is a view illustrating a radar control method according to the present embodiments.

A radar control method of a vehicle may include a transmitting a transmission signal and receiving a reception signal S500, a controlling to change a frequency slope of the transmission signal at a preset interval S510, and a processing a reception signal calculating a frequency deviation between the transmission signal and the reception signal and extracting an interference signal based on the frequency deviation S520.

The radar control method may include a transmitting a transmission signal and receiving a reception signal. (S500)

The radar control method may include a controlling to change a frequency slope of the transmission signal at a preset interval. (S510)

For example, the preset interval may be set based on a chirp and a scan.

The chirp may refer to one form in which the frequency increases or decreases over time when the horizontal axis is the time and the vertical axis is the frequency with respect to a two-dimensional graph. The transmission signal of the disclosure may refer to a signal having a chirp-type period in an FMCW format. Further, the scan may mean a form set to be composed of tens to hundreds of chirps. However, scan encompasses chirp in concept, and in the operation of controlling to change the frequency slope described below, the description focuses only on chirp.

For example, the frequency slope may be defined based on the above-described chirp. For example, the frequency slope may mean the degree to which the frequency increases or decreases over time, which may be calculated from a form of a chirp.

For example, the preset interval may be set based on N chirps (where N is a natural number of 1 or more), and accordingly, the frequency slope of the transmission signal may be controlled to be changed.

For example, the frequency slope of the transmission signal may be controlled to be changed at a preset interval. For example, the frequency slope of the transmission signal may be controlled to be changed for each chirp. In other words, after a transmission signal is transmitted at a specific frequency slope in one chirp, a transmission signal of which a specific frequency slope is changed may be transmitted in the next one chirp. As another example, the frequency of the transmission signal may be controlled to be changed in slope every three chirps. In other words, after three transmission signals are transmitted at a specific frequency slope in three chirps, a transmission signal of which a specific frequency slope is changed may be transmitted in the next three chirps. As another example, after three transmission signals are transmitted at a specific frequency slope in three chirps, the specific frequency slope is changed in one chirp and one transmission signal may be transmitted.

However, the preset interval may be set without limitations thereto.

For example, the radar control method may include controlling to change the frequency slope of the transmission signal. (S510)

For example, the controlling to change the frequency slope may control to transmit a first transmission signal controlled to have a normal frequency slope and a second transmission signal controlled to have a change frequency slope differentiated from the normal frequency slope.

Further, the change frequency slope may be set to be N times the normal frequency slope, and N may be set to a positive or negative number.

For example, the first transmission signal may be controlled to have the normal frequency slope, and the second transmission signal may be controlled to have a change frequency slope differentiated from the normal frequency slope. The change frequency slope may be set to be N times the normal frequency slope.

In this case, in order to calculate the frequency deviation described below to effectively extract the interference signal, the change frequency slope may be set to be N times the normal frequency slope, and N may be set to a positive or negative number.

For example, the change frequency slope may be set to be −1 times the normal frequency slope. In this case, the first transmission signal and the second transmission signal may have the same absolute value of the frequency slope, but may be determined to be inverted from each other. Accordingly, by using the first transmission signal and the second transmission signal inverted from each other, it may be easy to calculate a frequency deviation to be described below, and it may be more efficient to extract an interference signal included in the reception signal. In the present embodiments, for convenience of description, N is assumed to be −1 times, but N in the N times the slope may be variously set without limitations in the present embodiments.

The radar control method may include a processing a reception signal that calculates a frequency deviation between the transmission signal and the reception signal and extracts the interference signal based on the frequency deviation. (S520)

For example, the frequency deviation may be calculated in a manner of comparing the frequency of the transmission signal with the frequency of the reception signal to obtain the deviation. Accordingly, the frequency deviation may be calculated in a real number range (a range including a positive number, a negative number, and zero).

For example, the processing a reception signal may calculate the frequency deviation between the transmission signal and the reception signal and extract the interference signal according to the variation in the frequency deviation.

For example, the processing a reception signal may extract the interference signal by extracting a difference between a first frequency deviation calculated as a deviation between the first transmission signal and the reception signal and a second frequency deviation calculated as a deviation between the second transmission signal and the reception signal, as the variation in the frequency deviation.

For example, the variation in the frequency deviation may be calculated by comparing the time and frequency deviations based on the first frequency deviation and the second frequency deviation. Further, the variation in the frequency deviation may be extracted based on a preset threshold to be described below, and may be extracted based on an absolute value. Further, the variation in the frequency deviation may be extracted using the second transmission signal and the reception signal. For example, the form of the variation in the frequency deviation may include a form having a constant deviation over time, or may include a form in which the frequency deviation increases or decreases over time. Further, when the vehicle is driving, the variation in the frequency deviation may be variably calculated according to the speed. However, without limitations thereto, the variation in frequency deviation may be variously extracted.

For example, the processing a reception signal may extract the reception signal as the interference signal when the variation in the frequency deviation is larger than or equal to a predetermined threshold.

For example, the preset threshold may be preset with respect to the variation in the frequency deviation. For example, the preset threshold may mean a specific frequency deviation value when the specific frequency deviation is maintained for a predetermined time. Alternatively, it may mean a specific frequency deviation value when the absolute value of the specific frequency deviation is maintained for a predetermined time. Here, the predetermined time may be set to vary.

As another example, the processing a reception signal may apply an absolute value to each of the first frequency deviation and the second frequency deviation, extract a variation in the frequency deviation of the absolute value-applied first frequency deviation and the absolute value-applied second frequency deviation, and extract the reception signal as the interference signal when the variation in the frequency deviation exists.

For example, the variation in the frequency deviation may be extracted based on the absolute value of each of the first frequency deviation and the second frequency deviation. Here, the variation in the frequency deviation may mean a difference between the slopes of the absolute values of the first frequency deviation and the second frequency deviation. Here, if the variation in the frequency deviation is close to 0, it may be determined that the variation in the frequency deviation does not exist. Further, if there is a variation in frequency deviation, the reception signal may be extracted as the interference signal. However, without limitations thereto, the variation in frequency deviation may be extracted.

As another example, the processing a reception signal may extract the reception signal as the interference signal when the frequency deviation is changed.

Further, the frequency deviation may be calculated using the second transmission signal and the reception signal.

Further, when the frequency deviation is changed, the reception signal may be extracted as the interference signal. Due to the nature of the radar signal, the frequency deviation between the transmission signal and the reception signal reflected by the object targeted by the transmission signal may not be large in variation width. However, since the transmission signal and the interference signal may not be set to be the same or similar in frequency, period, or the like in advance, a change in frequency deviation may occur.

For example, the processing a reception signal may process the reception signal by deleting the pattern of the interference signal or the object according to the interference signal from the reception signal. The processing a reception signal may process the reception signal by deleting the pattern of the interference signal or the object included therein with respect to the extracted interference signal. Accordingly, the reception signal is a signal in which ghosting does not occur, and may make it easy to drive the vehicle in the autonomous driving system.

The above-described embodiments of the disclosure may be implemented in code that a computer may read out of a recording medium. The computer-readable recording medium includes all types of recording devices storing data readable by a computer system. Examples of the computer-readable recording medium include hard disk drives (HDDs), solid state disks (SSDs), silicon disk drives (SDDs), read-only memories (ROMs), random access memories (RAMs), CD-ROMS, magnetic tapes, floppy disks, or optical data storage devices, or carrier wave-type implementations (e.g., transmissions over the Internet).

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A radar control device of a vehicle, comprising:
a transceiver transmitting a transmission signal and receiving a reception signal;
a transmission signal controller controlling to change a frequency slope of the transmission signal at a preset interval; and
a reception signal processor calculating a frequency deviation between the transmission signal and the reception signal and extracting an interference signal based on the frequency deviation.

2. The radar control device of claim 1, wherein the transmission signal controller controls to transmit a first transmission signal controlled to have a normal frequency slope and a second transmission signal controlled to have a change frequency slope differentiated from the normal frequency slope.

3. The radar control device of claim 2, wherein the change frequency slope is set to be N times the normal frequency slope, and wherein N is set to a positive or negative number.

4. The radar control device of claim 2, wherein the reception signal processor calculates the frequency deviation between the transmission signal and the reception signal, and extracts the interference signal according to a variation in the frequency deviation.

5. The radar control device of claim 4, wherein the reception signal processor extracts the interference signal by extracting a difference between a first frequency deviation calculated as a deviation between the first transmission signal and the reception signal and a second frequency deviation calculated as a deviation between the second transmission signal and the reception signal, as the variation in the frequency deviation.

6. The radar control device of claim 5, wherein the reception signal processor extracts the reception signal as the interference signal when the variation in the frequency deviation is a preset threshold or more.

7. The radar control device of claim 5, wherein the reception signal processor applies an absolute value to each of the first frequency deviation and the second frequency deviation, extracts the variation in the frequency deviation of the absolute value-applied first frequency deviation and second frequency deviation, and extracts the reception signal as the interference signal when there is the variation in the frequency deviation.

8. The radar control device of claim 4, wherein the reception signal processor extracts the reception signal as the interference signal when the frequency deviation is varied.

9. The radar control device of claim 8, wherein the frequency deviation is calculated using the second transmission signal and the reception signal.

10. The radar control device of claim 1, wherein the reception signal processor processes the reception signal by deleting a pattern of the interference signal or an object according to the interference signal from the reception signal.

11. A radar control method of a vehicle, comprising:
a transmitting a transmission signal and receiving a reception signal;
a controlling to change a frequency slope of the transmission signal at a preset interval; and
a processing a reception signal for calculating a frequency deviation between the transmission signal and the reception signal and extracting an interference signal based on the frequency deviation.

12. The radar control method of claim 11, wherein the controlling to change the frequency slope controls to transmit a first transmission signal controlled to have a normal frequency slope and a second transmission signal controlled to have a change frequency slope differentiated from the normal frequency slope.

13. The radar control method of claim 12, wherein the change frequency slope is set to be N times the normal frequency slope, and wherein N is set to a positive or negative number.

14. The radar control method of claim 12, wherein the processing the reception signal calculates the frequency deviation between the transmission signal and the reception signal, and extracts the interference signal according to a variation in the frequency deviation.

15. The radar control method of claim 14, wherein the processing the reception signal extracts the interference signal by extracting a difference between a first frequency deviation calculated as a deviation between the first transmission signal and the reception signal and a second frequency deviation calculated as a deviation between the second transmission signal and the reception signal, as the variation in the frequency deviation.

16. The radar control method of claim 15, wherein the processing the reception signal extracts the reception signal as the interference signal when the variation in the frequency deviation is a preset threshold or more.

17. The radar control method of claim 15, wherein the processing the reception signal applies an absolute value to each of the first frequency deviation and the second frequency deviation, extracts the variation in the frequency deviation of the absolute value-applied first frequency deviation and second frequency deviation, and extracts the reception signal as the interference signal when there is the variation in the frequency deviation.

18. The radar control method of claim 14, wherein the processing the reception signal extracts the reception signal as the interference signal when the frequency deviation is varied.

19. The radar control method of claim 18, wherein the frequency deviation is calculated using the second transmission signal and the reception signal.

20. The radar control method of claim 11, wherein the processing the reception signal processes the reception signal by deleting a pattern of the interference signal or an object according to the interference signal from the reception signal.
